(19) United States
(12) Patent Application Publication
(10) Pub. No.: US 2017/0034355 A1
(43) Pub. Date: Feb. 2, 2017

(54) CALL CONTINUITY MANAGEMENT AND DISCONNECT NOTIFICATION

(71) Applicant: Avaya Inc., Santa Clara, CA (US)

(72) Inventors: Durgesh Kamat, Pune (IN); Puneet Kumar, Pune (IN); Prachi Kajaria, Pune (IN)

(21) Appl. No.: 14/812,002

(22) Filed: Jul. 29, 2015

(51) Int. Cl. H04M 3/533; H04M 3/537; H04W 40/02

(52) U.S. Cl. CPC H04M 3/53333; H04W 40/02; H04M 3/537; H04M 3/53308

(57) ABSTRACT

The use of devices, such as Fixed Mobile Convergence (FMC) devices, enables a user on a call to have the connection seamlessly transition from one network to another. However, a call that is disconnected, either pre-answer or post-answer, leaves the calling party without information as to why the call was disconnected. Herein, systems and signaling methods are provided whereby a reason for a disconnect can be created and passed to the calling party, such as in a text message, to inform the caller of the disconnect reason. Additionally, the reason may be provided to the called party's voicemail. The call server may then connect the calling party to the voicemail and, with the reason code, the voicemail server is able to announce the reason for the disconnect and provide the calling party the opportunity to leave a message for the called party. The called party, when available, may then be presented with the voicemail.

### FIELD OF THE DISCLOSURE

The present disclosure is generally directed toward telephony systems.

### BACKGROUND

Fixed Mobile Convergence (FMC) enables a user on a call to have the connection transition from one network to another. From the user's perspective, such a transition is automatic and seamless and the call may continue without any of the parties on the call being aware that the call has transitioned to a different network. Typically, one network is packet-based utilizing a signaling protocol, such as a Session Initiation Protocol (SIP) or Q-signaling (QSIG), and another network is switched-based, such as the public switched telephone network (PSTN). The packet-based network may comprise a fixed broadband network utilizing the Internet and components to connect to the Internet. The PSTN network may comprise a traditional “dial tone” network whereby a calling endpoint connects to a switching office, or offices, to establish a connection to a dialed endpoint.

Call routing systems provide a variety of services. For example, a caller may call a destination (a “callee”). The callee may have the call forked so as to be presented on different devices, which may be on different networks. While such a system provides many advantages, most notably the flexibility for a user to have calls routed to a number of devices or endpoints. The callee can then receive calls placed to them on one number, on two or more devices, without having to provide callers with multiple numbers or establish a “forward all calls,” when they think they will be away from one endpoint and near another, which they must remember to cancel when they return. Although call forking provides numerous advantages, certain problems remain.

### SUMMARY

It is with respect to the above issues and other problems that the embodiments presented herein were contemplated.

Parties engaged on a call may experience an unannounced or abrupt, intentional or unintentional, disconnection of the call. A notification may now be provided to the party still on the call. The notification may be a text message (e.g., SMS, IM, etc.), voicemail prompt, or other message. A voicemail prompt may further comprise an announcement of the reason for the disconnection, which may be generic (e.g., “Your call has been disconnected.”) or specific (e.g., “The other party has moved outside of the reception area and the call has been dropped.”). The disclosure herein may further facilitate seamless redirection to the disconnected party's voicemail to hear a message left by the connected party or re-engaging the parties and continue the call.

In a common enterprise network scenario, Caller has used their Device-A and Callee's extension, which is assigned to Device-B. The call is forked to Callee's FMC device, Device-C. The alerting call on Device-C is either intentionally disconnected on Device-C or the call answered on Device-C.

Problem 1: When the call is disconnected on Device-C, Callee's extension continues to alert and eventually the call is redirected to voicemail. If Device-C has intentionally disconnected and provided an SMS, the call is lost and does not get delivered to Caller or may not get delivered promptly.

Problem 2: The call is answered on Device-C and an active conversation is enabled between Caller and Callee on Device-C. Now, when Device-C goes out-of-network (e.g., enters an elevator or basement, battery dies, etc.), the call gets dropped abruptly and Caller does not get any indication or reason for call failure.

To address the problems above, solve other problems, and advance the state of the art, the disclosure herein provides, among other things, the following:

In a first, pre-answer, scenario, Caller users Device-D, an FMC device, to call Callee's Device-C, which is also an FMC device. Three cases arise in this situation: first, Device-C is busy and Callee's extension will stop alerting immediately and Caller is routed to Callee's voicemail; second, Device-C intentionally disconnects the alerting call, which is treated similarly as in the first situation, and the call is routed to voicemail and alerting stopped; and third, Callee intentionally disconnects the alerting call with an SMS. In this third situation, the SMS will be delivered to Caller's FMC device, Device-D, utilizing the mapping information for Caller's Device-D.

For all the three situations above, a private branch exchange (PBX) may initiate a call to voicemail with a new reason text, such as “disc-busy-ntwrk.” In response, the voicemail server may then play a specific greeting in accord with the reason such as, “Callee is currently busy,” “Callee is unable to answer,” “Callee has disconnected the call from their mobile device,” etc.

In a second, post-answer, scenario, Caller and Callee are engaged in a call, which is abruptly disconnected. Such a disconnection may occur due to Callee's Device-C going out-of-network. The PSTN network, such as Primary Rate Interface/SIP, may send a call disconnect indication to the enterprise PBX with the disconnect reason, which may comprise either the combination of a location and cause code or a reason header.

With the existing information provided to the PBX, the PBX may then determine the reason for the disconnection, such as the mobile device has gone out of the network. Therefore, instead of dropping the call abruptly, the PBX will move the current active call to Callee's voicemail. The disconnect information can then be used in the exchange between the PBX and the voicemail server. The specific interchange may depend on the signaling interface (e.g., SIP or QSIG) between the PBX and the voicemail server.

When using a SIP interface, the Diversion Header or History-Info header of the INVITE to voicemail may contain a new reason text (e.g., disc-out-of-ntwrk). When using a QSIG interface, the “divertingLegInformation2” of the SETUP message to the voicemail server may contain a new “diversionReason” (e.g., disc-out-of-ntwrk). With this information, the voicemail server may then be configured to play an announcement or customized greeting (e.g., “My device has gone out of network. Please leave a message and I will get back to you soon.”).

The caller is then informed that the call has been dropped and why the call has been dropped and may elect to leave a voice message. After leaving the message, or sooner if the caller elects not to leave a message, the caller is dropped from the call. After the message and the “drop,” PBX may receive a “Message Waiting” indication for Callee whereby the PBX may notify Callee on Device-C of the new voicemail. This can be achieved by the following: a) calling Device-C if/when it is back in the Network; and/or b) initiating a timer based outbound call if Device-C is, or remains, unreachable.

Implementation is variously embodied. In one embodiment, Device-C is still out-of-network when the PBX places a call to Device-C. The PBX will receive an error message code from the PSTN. An attempt to call Device-C may be made periodically. After Device-C is answered, Device-C is connected to the voicemail server whereby the message may then be presented to Callee. The calls may be made upon expiration of the timer the server attempts to ring Device-C promptly after the previous call terminates. The value of the timer may be selected to balance the need to conserve resources, by not making unnecessarily frequent call attempts, and the need to connect to Device-C promptly upon becoming available. In one embodiment, the timer is set for three minutes. After the timer expires, the PBX redials Device-C.

In another embodiment, Device-C is back in the network and has begun alerting. Once Device-C answers the call, the PBX will connect Device-C to the voicemail server and play the voicemail left by Caller. The voicemail server may provide an option to Device-C to place a call to Caller, such as when the message has finished playing or upon receiving a user input.

In one embodiment, a server is disclosed, comprising: a network interface configured to receive and route calls; a data store comprising a forking record for a called device indicating an associated forked device; a processor configured to receive a call, access the record, determine the call is addressed to the called device and, in response to the determination, generate a forked call to the forked device, and cause the network interface to route the forked call to the forked device; and the processor being further configured to, in response to the network interface receiving a disconnect message from the forked device, route the received call to a voicemail server associated with at least one of the called device and the forked device.

In another embodiment, a method is disclosed, comprising: receiving, a communication server, a call from a calling device to a called device; routing the call to the called device; accessing a forking record associated with a user and the called device; forking the call to a forked device selected in accord with the forking record; receiving a disconnect from the forked device; and in response to receiving the disconnect, connecting the calling device to a voicemail server associated with the called device.

In another embodiment, a system is disclosed, comprising: means for connecting a server to a communication network; means for receive a call from a calling device addressed to a called device; means to fork the received call to a forked device and thereby attempt to alert both the called device and the forked device to the call; means to, upon receiving a disconnect from the forked device, send the calling device a message indicating the reason for the disconnect.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium,” as used herein, refers to any tangible storage that participates in providing instructions to a processor for execution. Such a medium may take many forms, including, but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid-state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine,” “calculate,” and “compute,” and variations thereof, as used herein, are used interchangeably and include any type of methodology, process, mathematical operation or technique.

The term “module,” as used herein, refers to any known or later-developed hardware, software, firmware, artificial intelligence, fuzzy logic, or combination of hardware and software that is capable of performing the functionality associated with that element. Also, while the disclosure is described in terms of exemplary embodiments, it should be appreciated that other aspects of the disclosure can be separately claimed.

### BRIEF DESCRIPTION OF THE DRAWINGS

The present disclosure is described in conjunction with the appended figures:

FIG. 1 depicts a first system in accordance with embodiments of the present disclosure;

FIG. 2 depicts a second system in accordance with embodiments of the present disclosure;

FIG. 3 depicts a first interaction diagram in accordance with embodiments of the present disclosure;

FIG. 4 depicts a second interaction diagram in accordance with embodiments of the present disclosure;

FIG. 5 depicts a third interaction diagram in accordance with embodiments of the present disclosure;

FIG. 6 depicts a fourth interaction diagram in accordance with embodiments of the present disclosure;

FIG. 7 depicts a first process in accordance with embodiments of the present disclosure;

FIG. 8 depicts a second process in accordance with embodiments of the present disclosure; and

FIG. 9 depicts a server in accordance with embodiments of the present disclosure.

### DETAILED DESCRIPTION

The ensuing description provides embodiments only and is not intended to limit the scope, applicability, or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description comprising an element number, without a subelement identifier when a subelement identifier exists in the figures, when used in the plural, is intended to reference any two or more elements with a like element number. When such a reference is made in the singular form, it is intended to reference one of the elements with the like element number without limitation to a specific one of the elements. Any explicit usage herein to the contrary or providing further qualification or identification shall take precedence.

The exemplary systems and methods of this disclosure will also be described in relation to analysis software, modules, and associated analysis hardware. However, to avoid unnecessarily obscuring the present disclosure, the following description omits well-known structures, components, and devices that may be shown in block diagram form, and are well known, or are otherwise summarized.

For purposes of explanation, numerous details are set forth in order to provide a thorough understanding of the present disclosure. It should be appreciated, however, that the present disclosure may be practiced in a variety of ways beyond the specific details set forth herein.

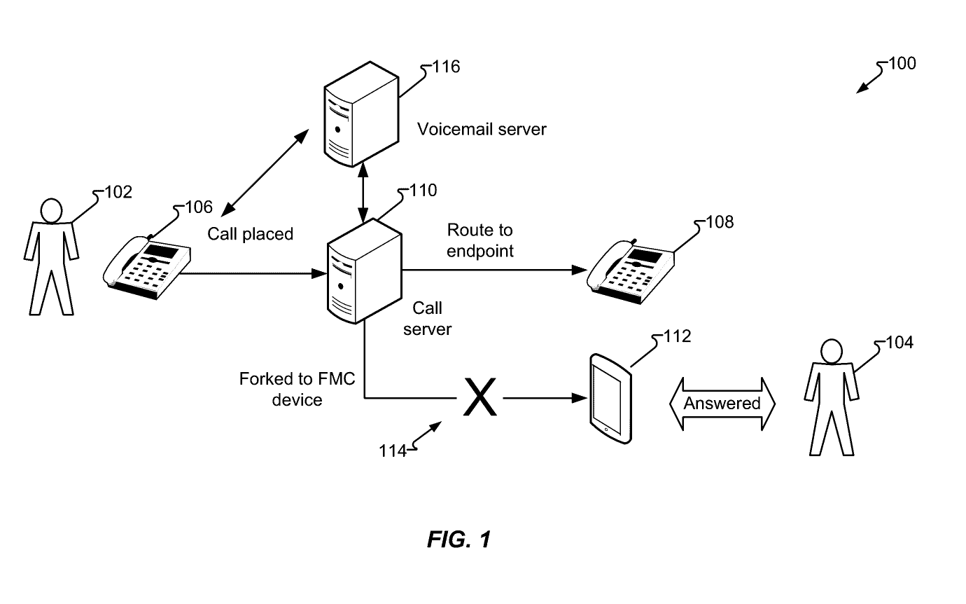

FIG. 1 depicts system 100 in accordance with embodiments of the present disclosure. In one embodiment, caller 102 places a call to the called party (herein, “callee 104”) by utilizing calling device 106 to place a call to called device 108. Between calling device 106 and called device 108 lies a plurality of communication and networking equipment to facilitate connectivity between calling device 106 and called device 108, such as call server 110. Call server 110 has been configured to fork incoming calls to called device 108 to forked device 112. As a result the incoming call may be presented on called device 108 and forked device 112.

Callee 104 answers the call utilizing forked device 112. After the call is answered, disconnect 114 causes forked device 112 to lose connectivity or otherwise be in operable to maintain the call. Disconnect 114 may be due to a variety of connectivity and/or endpoint issues. For example, disconnect 114 may be triggered by callee 104 disconnecting the call, whether intentionally or unintentionally. Additionally, disconnect 114 may be caused by forked device 112 itself, such as when forked device 112 exhausts its battery charge. Device 112 may be connected to call server 110 through one or more network links and components, any of which may fail to cause disconnect 114. For example, forked device 112 may move out of range or into a “dead spot” of a radio (e.g., Wi-Fi, Bluetooth, cellular, etc.) connection, become unplugged from a wired connection, etc.

In one embodiment, a network component, such as a PSTN component, reports the disconnect 114 to call server 110. Call server 110 may be a component of a PBX or other telephony subsystem operable to receive a disconnect notification of the call and formulate a message. The message comprises a reason code associated with the reason for the disconnect. The message, comprising the reason code, is forwarded to call server 110 that may perform the creation and sending of a text message to calling device 106 and/or the establishment of a connection between calling device 106 and voicemail server 116, which may present an announcement or greeting selected in accord with the disconnect reason and which is discussed in greater detail with respect to the embodiments below.

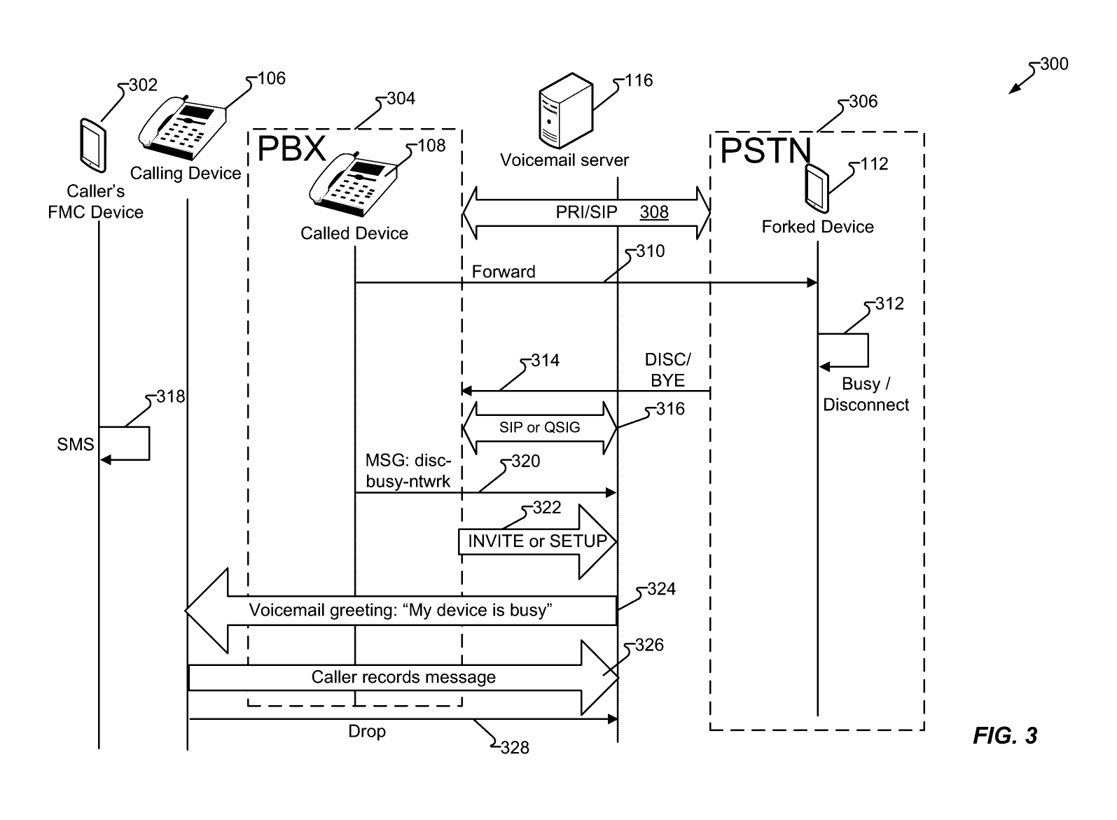

Call server 110 therefore provides notification to caller 102 via calling device 106 and/or a secondary device associated with caller 102 (see FIG. 3). As a benefit, caller 102 is made aware of the reason for the disconnect 114 as well as call server 110 being enabled to better manage the disconnect 114 and take appropriate responses to improve the overall operation of system 100. For example, call server 110, upon being informed of the disconnect 114, is associated with a dead battery within forked device 112 and may wait until forked device 112 returns to the network before attempting to perform any action with forked device 112, such as presenting voicemail server 116 to forked device 112 for the playback of a voicemail. Alternatively, if call server 110 has been informed that disconnect 114 occurred due to an abrupt out-of-network condition, which may be believed to be short-lived, for forked device 112 (e.g., callee 104 entered an elevator, drove into a tunnel, etc.), then call server 110 may apply a more aggressive strategy to reconnect to forked device 112, such as by periodically attempting to reconnect with forked device 112.

The components of system 100 are variously embodied. Calling device 106 and/or called device 108 may be an analog telephone, digital telephone, cellular phone, endpoint application on a computing device, etc. forked device 112 may comprise any form of telephony endpoint, such as those listed above with respect to calling device 106 and called device 108, when operable to operate as an FMC device. For example, forked device 112 may comprise functionality to report a reason code when disconnect 114 occurs as an action or condition upon forked device 112. While system 100 omits components generally understood in the art of analog and digital telecommunications, system 100 comprises call server 110 and voicemail server 116. Call server 110 and voicemail server 116 may be embodied as discrete components within system 100, integrated together, integrated with one or more other components, distributed between two or more components, or otherwise implemented on one or more physical devices.

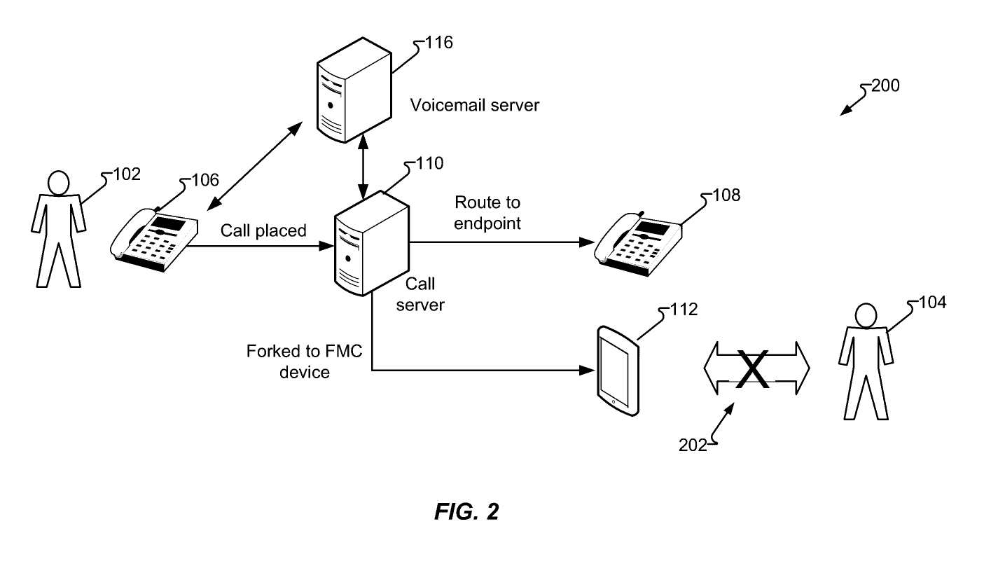

FIG. 2 depicts system 200 in accordance with embodiments of the present disclosure. In one embodiment, system 200 comprises components described with respect to FIG. 1. However, callee 104 has not answered forked device 112. The reason associated with callee 104 not answering forked device 112 is variously embodied and may include, callee 104 dropping the call, forked device 112 being busy, and/or a customized reason provided by callee 104 (e.g., “I'm in a meeting,” “unable to talk,” etc.).

Call server 110 receives a reason code associated with disconnect 202 and formulates a message to be delivered to calling device 106 and/or voicemail server 116. Call device 106 may present the reason associated with disconnect 202 in a human understandable form, such as a text message or spoken description. Additionally or alternatively, call server 110 may connect calling device 106 to voicemail server 116, whereby caller 102 may leave a message for callee 104. Additionally, voicemail server 116, having the reason for disconnect 202, may formulate or select a greeting or announcement to present to caller 102 as a precursor to caller 102 leaving a message for callee 104.

For example, disconnect 202 is associated with forked device 112 being currently busy. Disconnect 202 is reported by forked device 112 as “busy” to call server 110. Call server 110 sends a message to calling device 106 for presentation to caller 102 such as, “the called party is currently unavailable.” Calling party 102 may disconnect and try the call at a later time. Alternatively, calling party 102 may stay online and be presented with additional information, such as being connected to voicemail server 116 and presented with the additional information and/or greeting such as, “The called party is currently unavailable; however, if you would like to leave a message for the called party, please do so now.” Caller 102 may then leave a message for callee 104. Once callee 104 and/or forked device 112 becomes available, call server 110 may notify forked device 112 of the waiting voicemail message on voicemail server 116 or may even automatically connect forked device 112 to voicemail server 116 and initiate voicemail playback.

Call server 110 may be further configured to attempt to reconnect calling device 106 and forked device 112. For example, if calling device 106 is presently connected to voicemail server 116 and disconnect 202 occurs because forked device 112 is busy, and during this time forked device 112 becomes available, call server 110 may attempt to reconnect calling device 106 and forked device 112. Call server 110 and/or voicemail server 116 may also be configured to reconnect forked device 112 to calling device 106 after calling device 106 has dropped. For example, callee 104 may be presented with a voicemail message from caller 102 and, during or following playback of the message, callee 104 may indicate a desire to be reconnected to caller 102, thereby causing call server 110 to attempt to reconnect to calling device 106 and, if successful, reconnect calling device 106 to forked device 112.

In another embodiment, caller 102 may utilize a second device, such as a second FMC device. In such an embodiment, text messages may be delivered to calling device 106 and/or the secondary device (see FIG. 3).

FIG. 3 depicts interaction diagram 300 in accordance with embodiments of the present disclosure. Diagram 300 generally depicts a pre-answer response in accordance with embodiments herein. In one embodiment, calling device 106 initiated a call to called device 108. PBX 304 establishes trunking connection 308 with PSTN 306. Called device 108 wants to forward message 310 to forked device 112. Forked device 112 is either busy, disconnected, drops or indicates that the call should be dropped. PSTN 306 signals disconnect or BYE message 314 back to PBX 304, such as by call server 110, such as by signaling message 316 to voicemail server 116. Additionally message 320 provides a reason for the disconnect or non-answer. In one embodiment, message 320 utilizes a SIP protocol message such as INVITE message 322 to provide the reason for the disconnect or non-answer to the voicemail server 116. For example, “INVITE: sip:VoiceMail@company.com Diversion: callee@company.com; reason=disc-out-ntwrk.” In another embodiment, message 320 utilizes a QSIG protocol such as SETUP message 322. For example, “SETUP divertingLegInformation2: divertingNr: callee diversionReason: disc-out-of-ntwrk.”

Next, voicemail greeting 324 is presented to calling device 106 comprising a greeting or announcement indicating the reason for the disconnect or non-answer. Caller 102 may then utilize calling device 106 to record message 326 on voicemail server 116, after which calling device 106 may drop the connection to voicemail server 116 via drop 328.

Message 314 to PBX 304 may additionally be forwarded to calling device 106. However calling device 106 may itself be associated with a forking instruction whereby messages of a certain type (e.g., text messages) or other attribute may be forwarded to another device, such as caller 102's FMC device 302. Caller's FMC device 302 may then present the text message, or other message, as configured.

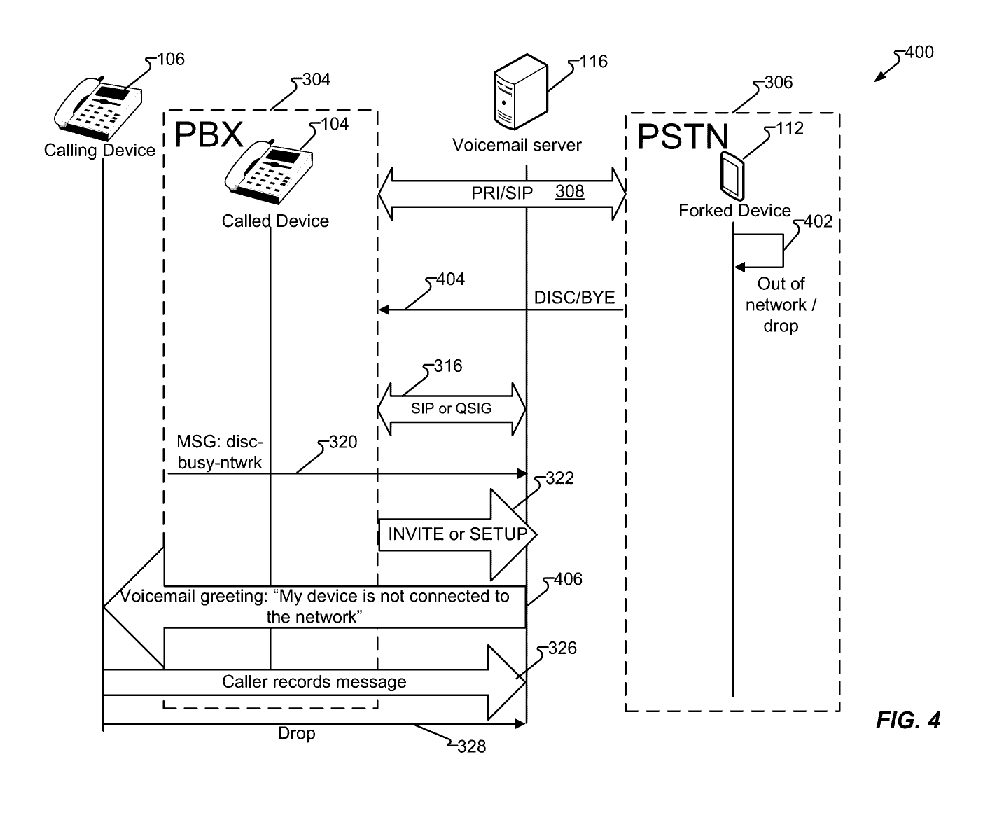

FIG. 4 depicts interaction diagram 400 in accordance with embodiments of the present disclosure. In one embodiment, diagram 400 illustrates a post-answer scenario whereby calling device 106 places a call to called device 104, which is forked to forked device 112 and answered by forked device 112. Trunking 308 occurs between PBX 304 and PSTN 306 and upon forked device 112 disconnecting 402, PSTN 306 causes disconnect by message 404 to be sent to PBX 304. In another embodiment forked device 112 is configured to initiate message 404, such as an indication that the battery life of forked device 112 is about to expire and the call is about to be dropped. Forked device 112 may be operable to send other messages, such as to indicate the degrading connectivity signal or a user's input, which is or is about to drop the call.

Signaling 316 that occurs between PBX 304 and voicemail server 116, which may then further comprise message 320 and the reason for the disconnect, is forwarded from PSTN 306 to PBX 304.

Additionally, message 320 provides a reason for the disconnect or non-answer. In one embodiment, message 320 utilizes a SIP protocol message, such as INVITE message 322, to provide the reason for the disconnect or non-answer to the voicemail server 116. For example, “INVITE: sip:VoiceMail@company.com Diversion: callee@company.com; reason=disc-out-ntwrk.” In another embodiment, message 320 utilizes a QSIG protocol and SETUP message 322. For example, “SETUP divertingLegInformation2: divertingNr: callee diversionReason: disc-out-of-ntwrk.”

Next, voicemail greeting 406 is presented to calling device 106 comprising a greeting or announcement indicating the reason for the disconnect or non-answer. Caller 102 may then utilize calling device 106 to record message 326 on voicemail server 116, after which calling device 106 may drop the connection to voicemail server 116 via drop 328.

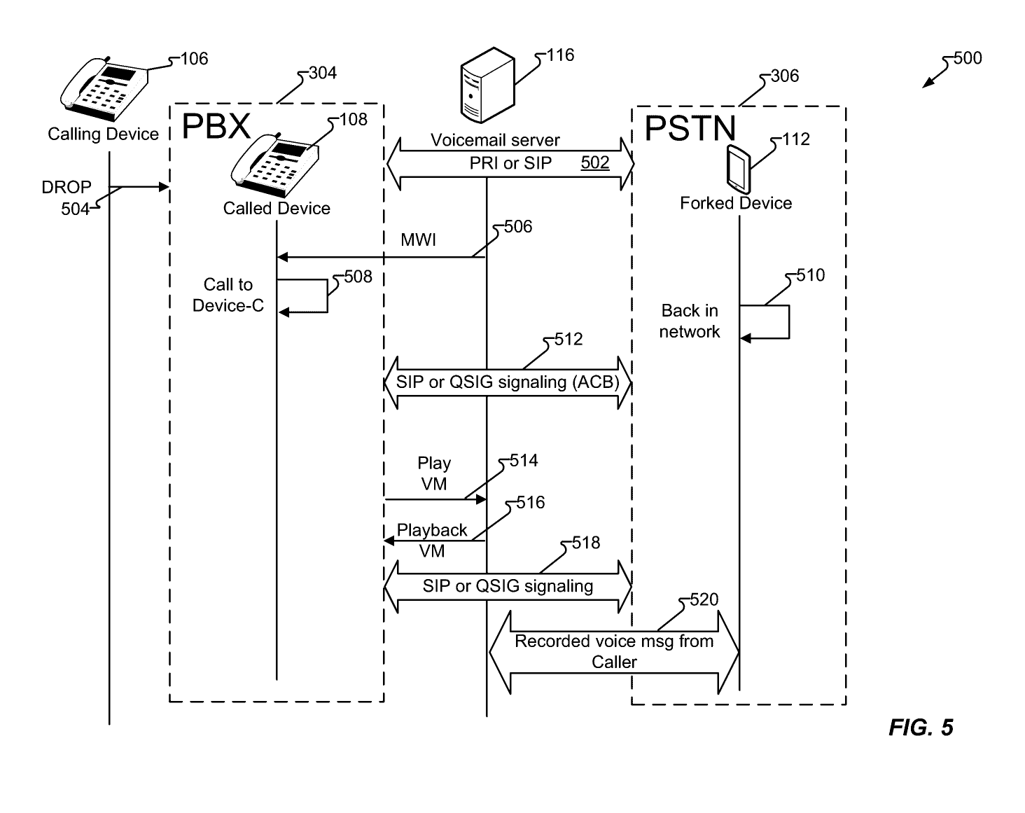

FIG. 5 depicts interaction diagram 500 in accordance with embodiments of the present disclosure. In one embodiment, diagram 500 illustrates an attempted reconnect following a disconnection, such as upon expiration of a timer. The timer may be progressive (e.g., wait 2 seconds, if no answer, wait 4 seconds, if no answer, wait 8 seconds, etc.). Calling device 106 performs dropped call 504 and is no longer on the call utilizing PBX 304. PBX 304 and PSTN 306 communicate using SIP or PRI signaling 502. Voicemail server 116 may provide a message waiting indicator (MWI) 506 to called device 108. Called device 108 or other component of PBX 304 may execute a call to Device-C 508 upon forked device 112 coming back to network 510. Back to network 510 may resolve the issue that caused a previous drop, such as out of network/drop 402 (see FIG. 4) or busy/disconnect 312 (see FIG. 3).

PBX 304 and PSTN 306 establish signaling messages 512, such as a request to play voice message 516 from voicemail server 116, which in turn responds with the playback of voice message 516. Additional signaling 518 may be provided such as to present recorded message 520 to forked device 112. Signaling 512 may be further embodied as a periodic redial to PSTN 306, and, in turn, forked device 112, and attempt to reestablish the connection with forked device 112. For example, signaling messages 512 may be initiated every three minutes in an attempt to reestablish the communication with forked device 112.

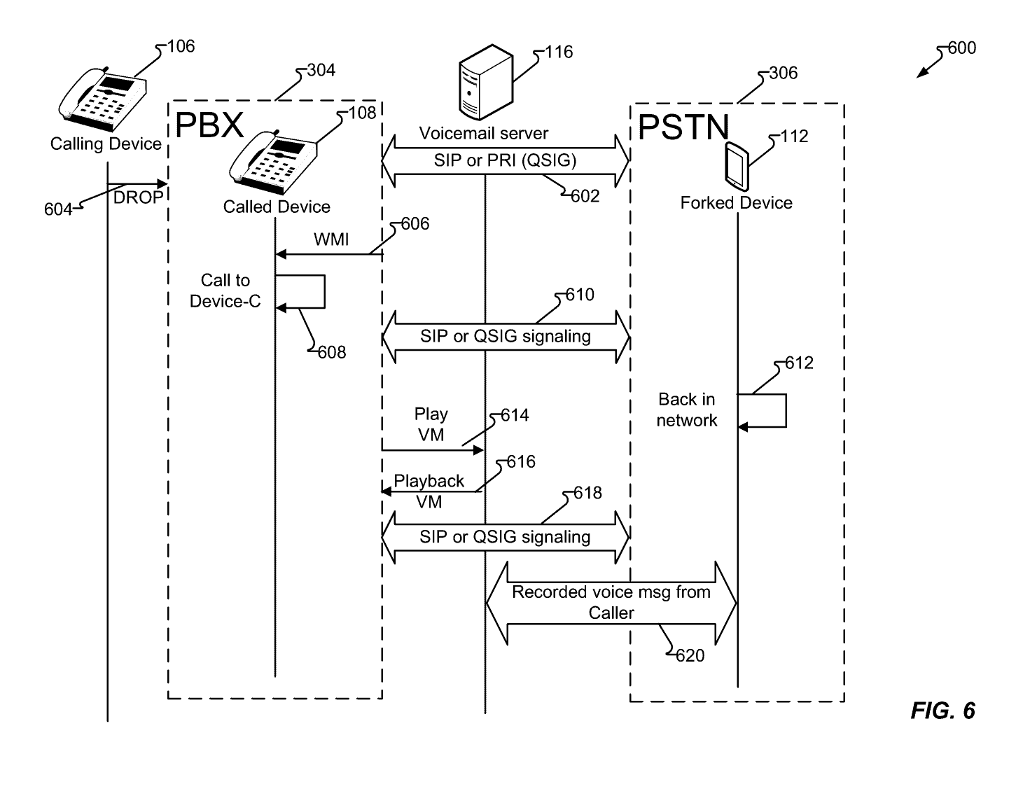

FIG. 6 depicts interaction diagram 600 in accordance with embodiments of the present disclosure. In one embodiment, diagram 600 illustrates a message playback following a disconnect. Calling device 106 performs dropped call 604 and is no longer on the call utilizing PBX 304. PBX 304 and PSTN 306 communicate using SIP or PRI signaling 602. Voicemail server 116 may provide a message waiting indicator (MWI) 606 to called device 108. Called device 108 or other component of PBX 304 may execute a call to Device-C 608 upon forked device 112 coming back to network 612. Coming back to network 612 may resolve the issue that caused a previous drop, such as out of network/drop 402 (see FIG. 4) or busy/disconnect 312 (see FIG. 3).

PBX 304 and PSTN 306 establish signaling messages 610 such as a request 614 to play voice message 616 to voicemail server 116, which in turn responds with the playback of a voice message 616. Additional signaling 618 may be provided such as to present recorded message 620 to forked device 112. Signaling 610 may be further embodied as a periodic call attempt to PSTN 306, and, in turn, forked device 112, and attempt to reestablish the connection with forked device 112. For example, signaling message 610 may be initiated every three minutes in an attempt to reestablish the communication with forked device 112.

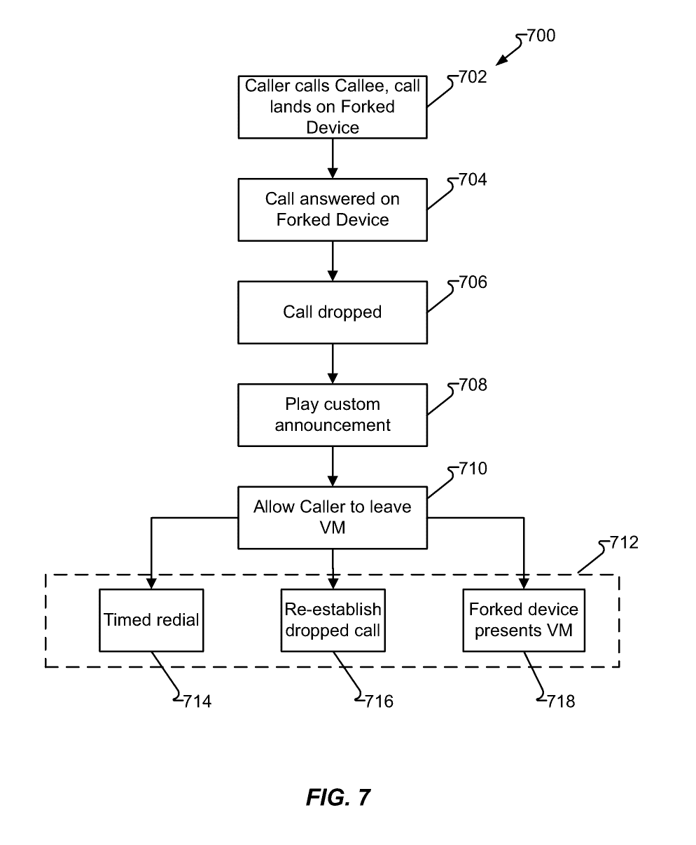

FIG. 7 depicts process 700 in accordance with embodiments of the present disclosure. In one embodiment, process 700 begins with step 702 where the caller 102 places a call to callee 104, such as when calling device 106 places the call to called device 108. The call is answered in step 704 on the forked device, such as forked device 112. At some point during the call at step 706, the call is dropped. The call may be dropped deliberately or accidentally; however, caller 102 may be unaware that the call has been dropped or the reason the call was dropped.

In step 708, a custom announcement is played to the caller 102 incorporating a reason for the disconnect. Step 710 allows caller 102 to leave a voice message for the callee 104. Subsequent action 712 comprises options that may be implemented as a matter of design or configuration. If any options within a subsequent action 712 are utilized, any one or more options may be further selected. For example, step 714 initiates a retry attempt to the callee 104. Step 716 attempts to re-establish the dropped call. Step 716 may be operable as long as the caller 102 is still connected or, if disconnected, attempts to call back the callee 104 as well as the caller 102. Step 718 presents the voice message on forked device 112.

In another embodiment, access to the voicemail left by the caller 102 is provided by retrieving a voice message from another device, such as the called device, such as called device 108. Such may be expected when forked device 112 is inoperable for a significant amount of time (e.g., lost, broken, etc.) or callee 104 has become proximate to or prefers to utilize called device 108.

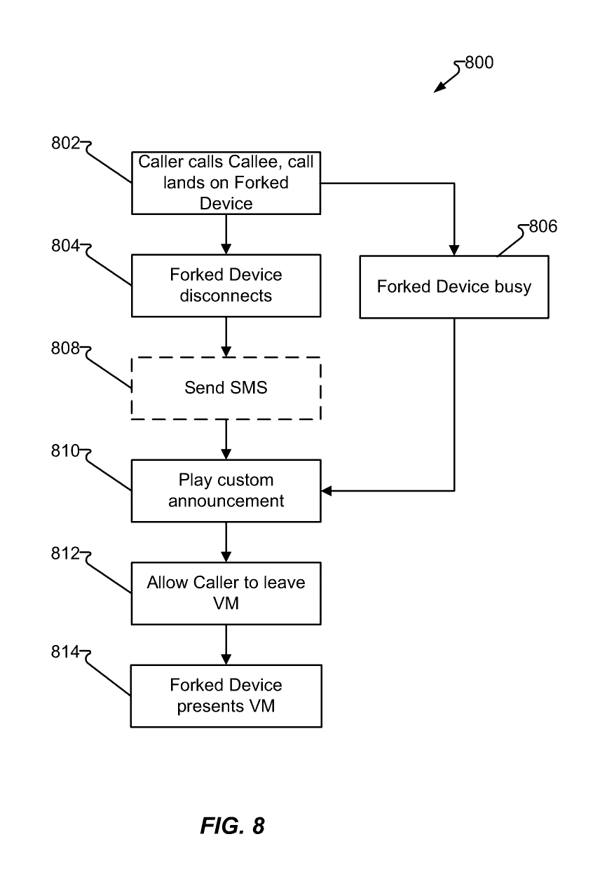

FIG. 8 depicts process 800 in accordance with embodiments of the present disclosure. In one embodiment, process 800 begins with step 802 wherein the caller calls callee, such as when caller 102 utilizing calling device 106 places a call to callee 104 addressed to the endpoint called device 108. The call is then forked to forked device 112, such as by call server 110. After the call is initiated, step 804 may be executed when the call is connected, whether or not answered, and later disconnected. Step 806 may be a failure to connect or otherwise reach the forked device 112.

In one embodiment, step 808 is selectively executed or not executed whereby text message, such as an SMS message, is sent addressed to the calling device 106. Step 808 may be executed by forked device 112 or a different component of the network, such as call server 110. The SMS message may comprise a translation of a reason code associated with the disconnect that occurred in step 804.

Caller 102 may be presented with a custom announcement in step 810 as a precursor to leaving a voice message. In addition to, or as an alternative to, the reason code associated with the disconnect in step 804 may be provided as a portion of the announcement presented in step 810. Next step 812 allows the caller to leave a voice message, which, in step 814, is presented to forked device 112 and callee 104.

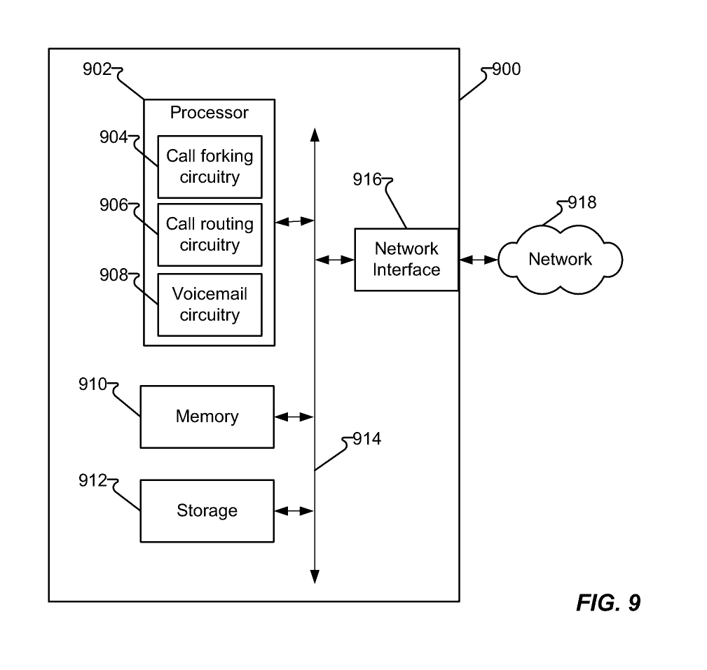

FIG. 9 depicts server 900 in accordance with embodiments of the present disclosure. In one embodiment, server 900 comprises functionality of both call server 110 and voicemail server 116. However, it should be appreciated that server 900 may comprise the addition or omission of certain components. For example, in another embodiment, server 900 omits voicemail circuitry 900 when embodied as call server 110. In another embodiment, server 900 omits call forking circuitry 904 and call routing circuitry 906 when embodied as voicemail server 116. It should be appreciated that well-known server components are omitted from the figure to avoid unnecessarily complicating the figure.

Server 900 comprises various electronic, optoelectronic, and/or electromechanical internal components and communicates with external components via network interface 916 connected to network 918. Network interface 916 may be a single interface, such as to network 918 enabling communication with one or more other components. In another embodiment, network interface 916 may comprise a number of communication interfaces. For example, a dedicated communication interface between components, such between one of call server 110 and voicemail server 116 when embodied as discrete instances of server 900. Network interface 916 may comprise an interface to an internal network (e.g., Ethernet, WiFi, etc.) and/or external network (e.g., Internet, PSTN, etc.).

Processor 902 provides circuitry to perform computational operations, such as registers, I/O unit, buffers, queue pointers, etc. which may be configured upon loading of software or, in another embodiment, circuit-programmed (e.g., ASIC). Additionally, processor 902 may comprise one or more of call forking circuitry 904, call routing circuitry 906, and voicemail circuitry 908. Memory for server 902 may be provided by on-chip memory and/or memory 910 providing off-chip memory, such as via a memory card or motherboard memory circuitry. Additional storage is provided by storage 912 which may comprise a magnetic, electrical, optical, or other storage circuitry and components. In another embodiment, one or more components, such as processor 902, memory 910, and storage 912 may be provided, in whole or in part, outside of server 900 such as when server 900 is load-balanced with one or more other servers, shared in a “cloud” based processing or storage network, or otherwise comprises distributed functionality. Storage 912 and/or memory 910 may contain call forking records, voicemail storage, preconfigured voicemail announcements, rules to generate a voicemail announcement, call directory, address book, message creation rules, programming for processor 902, and/or other data and instructions accessible by at least processor 902.

Server 900 comprises an internal bus 914 to facilitate communication between components within server 900. Internal bus 914 may be any data-conveyance system, including but not limited to one or more of a bus, backplane, cable, PCI, PCIe, etc. providing control, address, and/or data conveyance. Server 900 comprises one or more additional internal components, such as processor 902, memory 910, and storage 912.

In one embodiment, server 900 comprises the functionality of call server 110. Accordingly, network interface 916 provides components to send and receive electrical, radio wave, and/or optical signals to network 918, such as for the sending, routing, and forking of calls.

In the foregoing description, for the purposes of illustration, methods were described in a particular order. It should be appreciated that in alternate embodiments, the methods may be performed in a different order than that described. It should also be appreciated that the methods described above may improve the performance of computer systems, components thereof, and/or the interworkings between systems and/or components. Certain embodiments or portions thereof may be embodied in sequences of machine-executable instructions, which may be used to cause a machine, such as a general-purpose computer configured to operate in a specific manner, a special-purpose processor (GPU or CPU), or the use and/or incorporation of special circuitry, application specific integrated circuit (ASIC), or logic circuits programmed with the instructions to perform the methods, such as by a field programmable gate array (FPGA). These machine-executable instructions may be stored on one or more machine-readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process, which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine-readable medium, such as a storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

1. A server, comprising:
a network interface configured to receive and route calls;
a data store comprising a forking record for a called device indicating an associated forked device;
a processor configured to receive a call, access the forking record, determine the call is addressed to the called device and, in response to the determination, generate a forked call to the forked device, and cause the network interface to route the forked call to the forked device; and
the processor being further configured to, in response to the network interface receiving a disconnect message from the forked device, route the received call to a voicemail server associated with at least one of the called device and the forked device.

2. The server of claim 1, further comprising a private branch exchange (PBX).

3. The server of claim 1, wherein the processor, upon receiving the disconnect message, is further configured to:
connect the call to the voicemail server; and
cause the voicemail server to present an announcement message, the announcement message comprising a reason for the disconnect.

4. The server of claim 3, wherein the reason for the disconnect comprises one or more of out-of-network, call disconnected, device busy, and unavailable.

5. The server of claim 3, wherein the processor is further configured to cause an announcement to be presented to a calling device comprising a notification selected in accord with the reason.

6. The server of claim 1, wherein the disconnect message indicates an intentional disconnect of the call by the forked device.

7. The server of claim 1, wherein the processor, upon receiving the disconnect message, is further configured to send a text message reporting the disconnect to a calling device.

8. The server of claim 1, wherein the processor, upon receiving the disconnect message from the forked device, terminates call notification to the called device.

9. The server of claim 1, wherein at least one of the forked device and the calling device comprises a Fixed Mobile Convergence (FMC) device.

10. The server of claim 1, wherein the processor, in response to the disconnect message, performs a timed connection retry to the forked device and upon the call being answered, connects the forked device to the voicemail server.

11. A method, comprising:
receiving, a communication server, a call from a calling device to a called device;
routing the call to the called device;
accessing a forking record associated with a user and the called device;
forking the call to a forked device selected in accord with the forking record;
receiving a disconnect from the forked device; and
in response to receiving the disconnect, connecting the calling device to a voicemail server associated with the called device.

12. The method of claim 11, further comprising:
receiving a disconnect reason;
providing the disconnect reason to the voicemail server; and
presenting, by the voicemail server, an announcement comprising a human-perceivable disconnect reason selected in accord with the disconnect reason.

13. The method of claim 11, wherein the disconnect is received prior to the call being answered.

14. The method of claim 11, further comprising:
receiving a disconnect reason;
originating a text message comprising a human-readable disconnect reason text portion selected in accord with the disconnect reason; and
sending the text message to the calling device.

15. The method of claim 11, further comprising:
receiving a disconnect reason; and
upon determining the disconnect reason comprises a non-intentional disconnect reason, performing a timed connection retry to the forked device, the timed connection retry comprising a previously selected number and frequency of attempts to re-connect to the forked device.

16. The method of claim 15, further comprising:
upon successfully reconnecting to the forked device, connecting the forked device to the voicemail server to enable stored message playback.

17. The method of claim 15, further comprising:
upon successfully reconnecting to the forked device, connecting the forked device to the calling device.

18. A system, comprising:
means for connecting a server to a communication network;
means for receiving a call from a calling device addressed to a called device;
means for forking the received call to a forked device and thereby attempting to alert both the called device and the forked device to the call;
means for, upon receiving a disconnect from the forked device, sending the calling device a message indicating a reason for the disconnect.

19. The system of claim 18, further comprising, upon receiving the disconnect, connecting the calling device to a voicemail server, whereby a user of the calling device may leave a message for a user of the called device.

20. The system of claim 19, further comprising, means to provide the reason for the disconnect to the voicemail server and further comprising, means for the voicemail server to present an audible translation of the reason for the disconnect to the user of the calling device.
